(19) United States
(12) Patent Application Publication
(10) Pub. No.: US 2016/0153618 A1
(43) Pub. Date: Jun. 2, 2016

(54) LIGHT ASSEMBLY

(71) Applicant: LITE-ON TECHNOLOGY CORPORATION, Taipei (TW)

(72) Inventors: Yi-Kai CHENG, Taipei (TW); Shih-Chang WANG, Taipei (TW)

(21) Appl. No.: 14/557,258

(22) Filed: Dec. 1, 2014

(51) Int. Cl. F21K 99/00; F21V 13/04

(52) U.S. Cl. CPC F21K 9/17; F21K 9/50; F21V 13/04; F21Y 2101/02

(57) ABSTRACT

A light assembly is provided. The light assembly comprises at least one light bar. Each of the at least one light bar comprises at least one point light source and a lens. The lens is disposed over the point light source for directing the light emitted from the point light source along an extending direction of the light bar.

### BACKGROUND

1. Technical Field

The disclosure relates to a light assembly.

2. Description of the Related Art

Point light sources, such as light emitting diodes (LEDs), have been widely used to form various luminous patterns. Other than those patterns having complicated configurations, patterns of simple lines constituted by LED are also common. The application of the later one comprises countdown lights, traffic lights such as arrow and X signals, etc.

In a typical two-digit countdown light, 196 LEDs are used. 14 LEDs are used in a line pattern and seven line patterns are used for a number 8 layout. Then countdown number can be constituted by the 14 line patterns. All of these LEDs must have similar light intensity for illumination uniformity and visual appearance. In addition, generally, the LEDs are connected to the circuit board separately, resulting in a complicated circuit layout. Further, since the LEDs are typically connected to the circuit board individually, the product manufacturing process is time consuming and complicated. The manufacturing for other light assembly comprising simple line luminous patterns face the same problems.

### SUMMARY

In the embodiments of this disclosure, a light assembly able to be produced by a timesaving and simple process is provided. The light assembly is provided with at least one light bar including only one point light source and a lens for converting the light field of the point light source from a sphere to an elongated configuration.

According to one embodiment, a light assembly comprises at least one light bar. Each of the at least one light bar comprises at least one point light source and a lens. The lens is disposed over the point light source for directing the light emitted from the point light source along an extending direction of the light bar.

According to one embodiment, a light assembly comprises a luminous pattern constituted by a plurality of light bars. Each of the light bars comprises at least one point light source and a lens. The lens is disposed over the point light source for directing the light emitted from the point light source along an extending direction of the light bar.

### BRIEF DESCRIPTION OF THE DRAWINGS

FIG. 1 shows a light assembly according to one exemplary embodiment.

FIGS. 2A-2C schematically illustrate a light bar according to one embodiment.

FIGS. 3-5 schematically illustrate various light bars according to different embodiments.

FIGS. 6A-6B schematically illustrate the luminous condition of a light bar according to one embodiment.

FIG. 7 schematically illustrates the luminous conditions of a light assembly according to one exemplary embodiment.

FIG. 8 shows a light assembly according to another exemplary embodiment.

FIG. 9 shows a light assembly according to still another exemplary embodiment.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

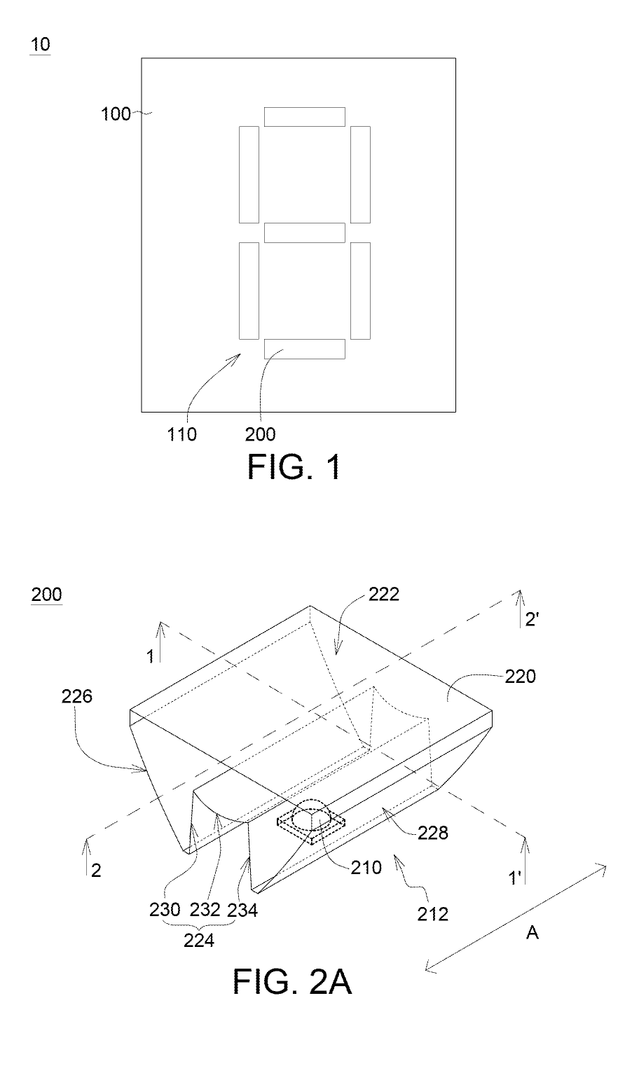

Referring to FIG. 1, a light assembly 10 according to one exemplary embodiment is shown. The light assembly 10 comprises a circuit board 100 and a luminous pattern 110. The circuit board 100 may be a printed circuit board or the like. The luminous pattern 110 is constituted by at least one light bar 200, which is disposed on and electrically connected to the circuit board 100. In the example of FIG. 1, the luminous pattern 110 is a number 8. The luminous pattern 110 is constituted by seven light bars 200.

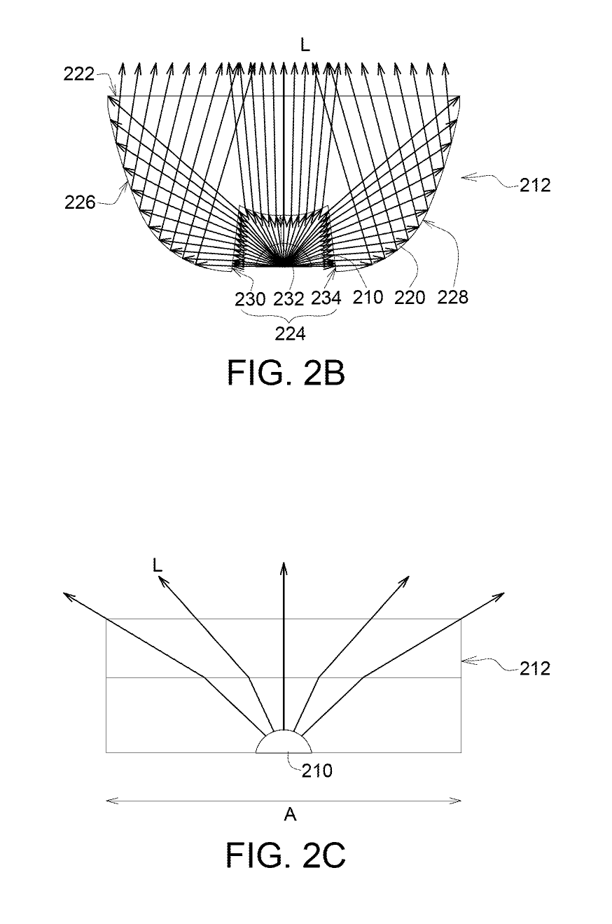

Referring to FIGS. 2A-2C, one of the light bars 200 according to one embodiment is shown. FIG. 2A schematically illustrates a perspective view of the light bar 200. FIG. 2B schematically illustrates a cross sectional view of the light bar 200 taken across the 1-1′ plane in FIG. 2A. FIG. 2C schematically illustrates a cross sectional view of the light bar 200 taken across the 2-2′ plane in FIG. 2A, which extends along the extending direction A of the light bar 200.

As shown in FIG. 2A, the light bar 200 comprises a point light source 210 and a lens 212. The point light source 210 is used for emitting a light. The lens 212 is disposed over the point light source 210 for directing the light emitted from the point light source 210 along the extending direction A of the light bar 200. As such, the light field of the point light source 210 is converted by the lens 212 to an one-axial elongated configuration.

The point light source 210 may be a LED device. A red LED, a blue LED, a green LED or the like may be used. The LED device may comprise a high power LED. In some embodiments, the power of the high power LED is 0.5 W to 3 W, for example, 0.5 W to 1 W, or 1 W to 3 W. In the embodiments provided in this disclosure, the light bar 200 comprises only one point light source 210 since a single point light source 210 is enough for each light bar 200. However, more than one point light source 210 may be used for backup, color change, or other considerations.

The lens 212 may be a secondary lens of the point light source 210. Generally, such a secondary lens may be formed of a transparent material such as acrylic or polycarbonate (PC). Light direction from the point light source 210 may be changed by the lens 212. By the lens 212, light distribution from the point light source 210 can be converted to desired distribution.

Referring to FIG. 2B, in some embodiments, the lens 212 comprises a lens body 220. The lens body 220 has a light emitting surface 222, a light refractive surface 224, a first light reflective surface 226 and a second light reflective surface 228. The light refractive surface 224 defines a space in which the point light source 210 is received. The first light reflective surface 226 connects the rectangular light emitting surface 222 and the light refractive surface 224. The second light reflective surface 228 connects the rectangular light emitting surface 222 and the light refractive surface 224 and is opposite to the first light reflective surface 226. Part of the light L emitted from the point light source 210 is refracted by the light refractive surface 224 and leaves the light bar 200 from the light emitting surface 222. Another part of the light L emitted from the point light source 210 is reflected by the first and the second light reflective surfaces 226, 228 and leaves the light bar 200 from the light emitting surface 222.

Specifically, as shown in FIG. 2B, the light refractive surface 224 may comprise a first side refractive surface 230, a top refractive surface 232 and a second side refractive surface 234. In the example of FIG. 2B, the first and the second side refractive surfaces 230 and 232 are the refractive surfaces close to the first and the second light reflective surfaces 226 and 228, respectively. The first and the second light reflective surface 226 and 228 are acting as total internal reflection surfaces. In the example of FIG. 2B, the top refractive surface 232 is convex toward the point light source 210. The point light source 210 is received in the space defined by the first side refractive surface 230, the top refractive surface 232 and the second side refractive surface 234. The light refractive surface 224 as shown in FIG. 2B is beneficial for the refraction of the light L, however, the light refractive surface 224 would not be limited thereto.

While a cross sectional configuration of the lens 212 is provided in FIG. 2B, the lens 212 may have a different type of the cross sectional configuration, as long as the light L emitted from the point light source 210 can be directed along the extending direction A of the light bar 200 by the lens 212, as illustrated in FIG. 2C. Further, in some embodiments, the lens 212 may have color and the point light source 210 is a white LED.

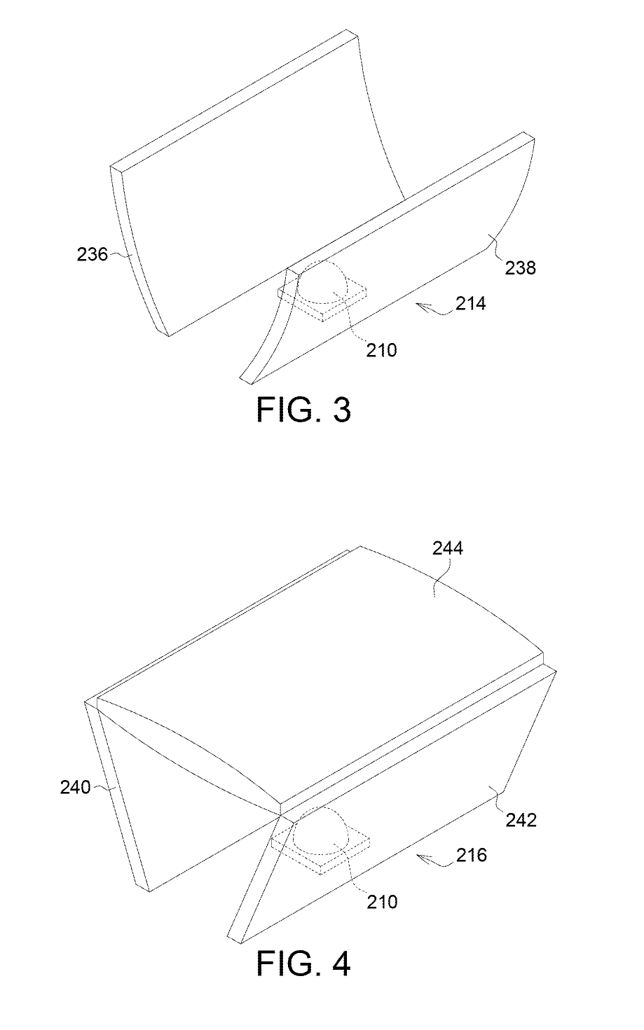

Now referring to FIGS. 3-5, some other lens configurations are shown. In the embodiment shown in FIG. 3, the lens 214 comprises two light reflective lens bodies 236 and 238, which are disposed opposite to each other. The light reflective lens bodies 236 and 238 reflect the light emitted from the point light source 210. The light reflective lens bodies 236 and 238 have curved reflective surfaces. The curvature of the surfaces is selected so that the reflected light is directed to desired direction.

In the embodiment shown in FIG. 4, the lens 216 comprises two light reflective lens bodies 240, 242 and a light emitting lens body 244. The two light reflective lens bodies 240 and 242 are disposed opposite to each other, and the light emitting lens body 244 connects the top portions of the two light reflective lens bodies 240 and 242. The light reflective lens bodies 240 and 242 have flat surfaces to reflect the light emitted from the point light source 210. The reflected light is emitted from the light emitting lens body 244. The light emitting lens body 244 is a convex lens.

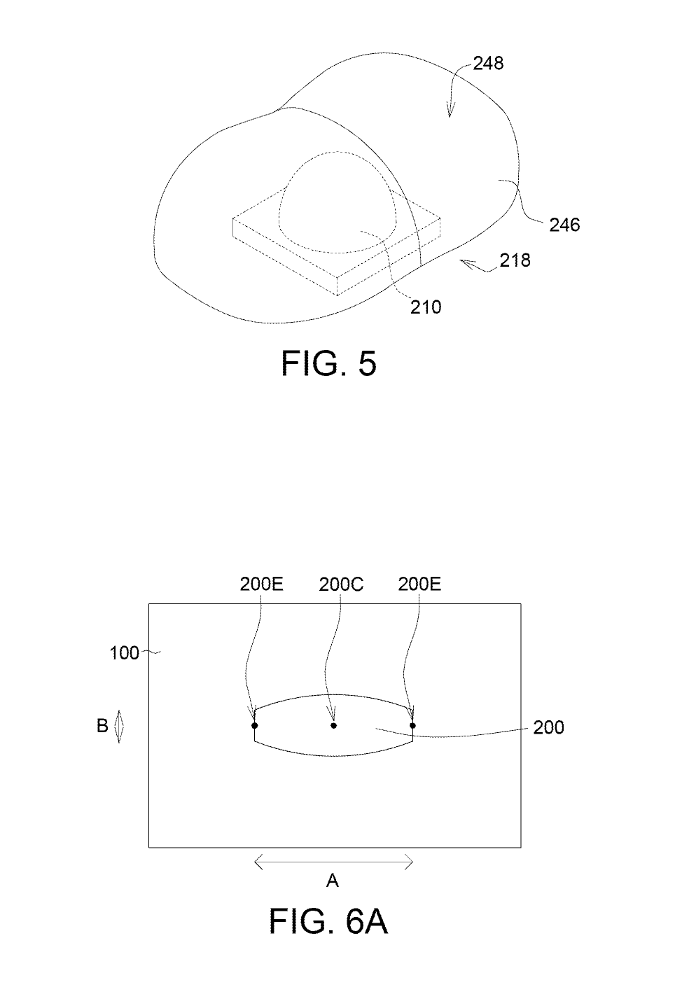

In the embodiment shown in FIG. 5, the lens 218 comprises a curved body 246, which is shaped like a peanut shell. The curved body 246 has a light reflective, refractive and emitting surface 248. That is, the light emitted from the light source 210 is reflected, refracted and emitted from the curved surface 248.

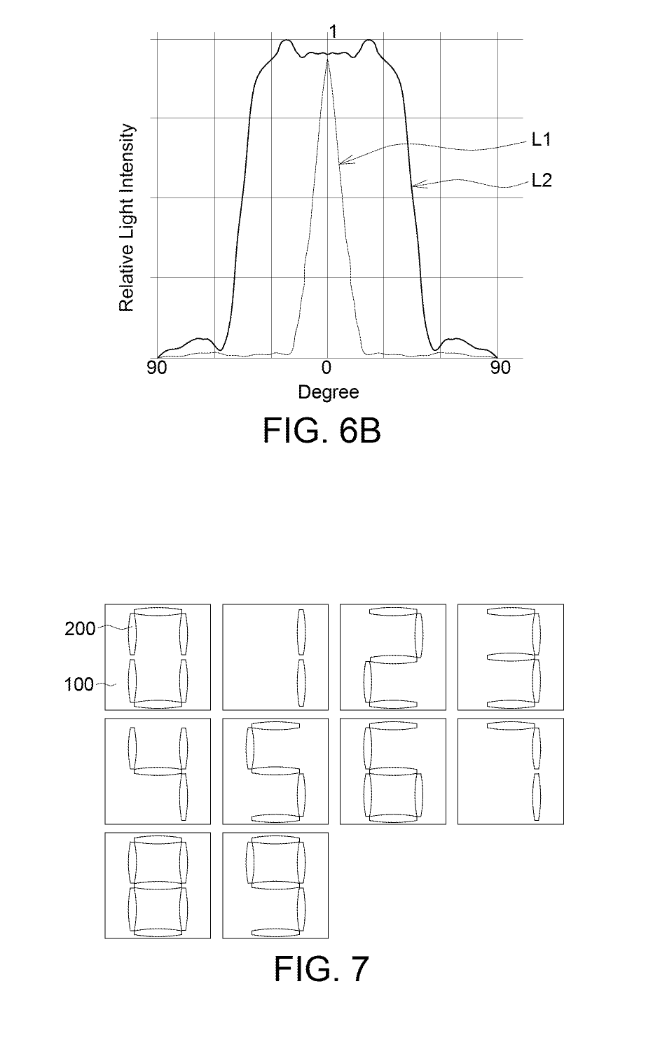

FIGS. 6A-6B schematically illustrate the luminous condition of the light bar 200 according to one embodiment. FIG. 6A is a schematic diagram showing the top view of a turned-on light bar 200, wherein the bright area and the dark area are represented by the empty region and the dotted region, respectively. FIG. 6B shows the distribution curve of luminous intensity of the light bar 200. The luminous intensity distribution in the width direction B of the light bar 200 is indicated by curve L1, and the distribution in the length direction (i.e., the extending direction A of the light bar 200) is indicated by curve L2. It should be noted that the light L emitted from the point light source 210 can be directed, through the lens 212/214/216/218, much wider in the extending direction A (see L2) than in the width direction B (see L1). In some embodiments, an intensity of the light emitted from the ends of the light bar 200E is higher than 50% of an intensity of the light emitted from the center of the light bar 200C.

Referring now to FIG. 7, the luminous conditions of the light assembly 10 shown in FIG. 1 are schematically illustrated. Seven light bars 200 are arranged in a number 8 layout. These light bars 200 can be switched on and off individually, so as to create and display different numbers. Each number from 0 to 9 is schematically shown. In some embodiment, the color of the LED, the lens 212/214/216/218 and/or a cover of the light assembly 10 may be adjusted and coordinated to display numbers with various colors, such as yellow or amber.

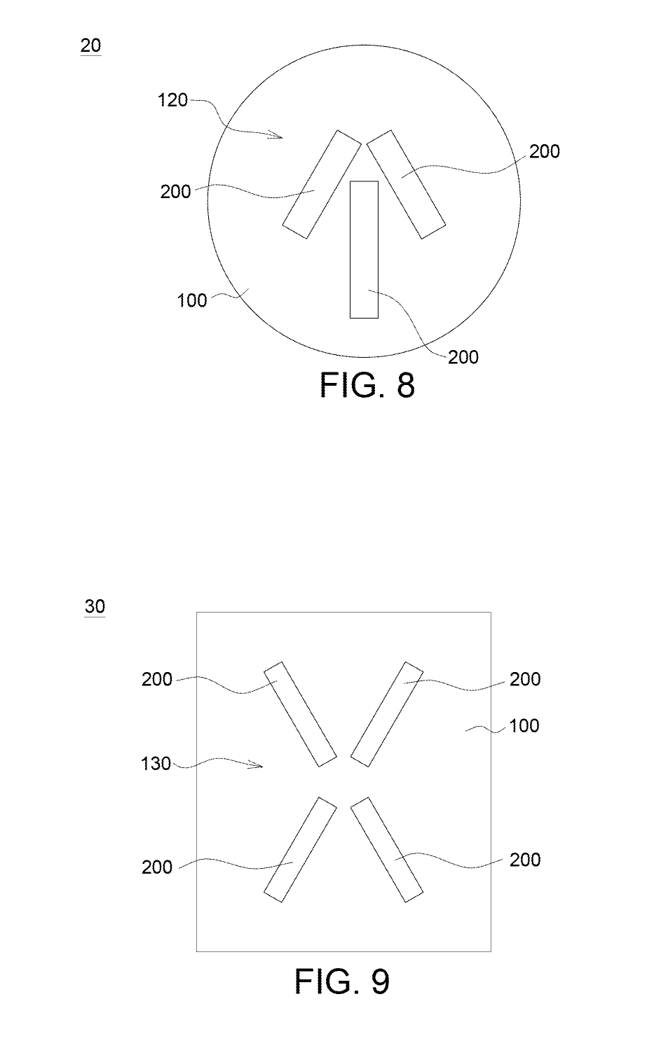

Referring to FIG. 8, a light assembly 20 according to another exemplary embodiment is shown. The light assembly 20 comprises a circuit board 100 and a luminous pattern 120 different from the luminous pattern 110. The luminous pattern 120 is an arrow and constituted by three light bars 200. The light assembly 20 may be used as a traffic light. In such cases, the color of the LED, the lens 212/214/216/218 and/or a cover of the light assembly 20 may be adjusted and coordinated to display a green arrow.

Referring to FIG. 9 a light assembly 30 according to still another exemplary embodiment is shown. The light assembly 30 comprises a circuit board 100 and a luminous pattern 130, which is a letter X constituted by four light bars 200. The light assembly 30 may also be used as a traffic light. The light assembly 30 may be used together with a light assembly showing an arrow (as the example of FIG. 8). In such cases, the color of the LED, the lens 212/214/216/218 and/or a cover of the light assembly 30 may be adjusted and coordinated to display a yellow or red X signal.

The above exemplary embodiments, compared to those conventional light assemblies having a luminous pattern comprising a simple line, need less point light sources (such as LED). As such, the expended time of the mounting process, package, etc., is decreased. The circuit layout can be simplified. The cost of each light assembly can be significantly decreased. Thus, a light assembly according to the embodiments of this disclosure may be much “green” than a conventional one.

It will be apparent to those skilled in the art that various modifications and variations can be made to the disclosed embodiments. A light assembly according to the embodiments of this disclosure may comprise one or more light bars each including a point light source and a lens for directing the light emitted from the point light source along an extending direction of the light bar. The light bars may be used or arranged in various luminous patterns comprise a single straight line. It is intended that the specification and examples be considered as exemplary only, with a true scope of the disclosure being indicated by the following claims and their equivalents.

What is claimed is:

1. A light assembly, comprising:
at least one light bar, each of the at least one light bar comprising:
at least one point light source for emitting a light; and
a lens disposed over the point light source for directing the light emitted from the point light source along an extending direction of the light bar.

2. The light assembly according to claim 1, wherein the lens comprises a lens body having:
a light emitting surface;
a light refractive surface;
a first light reflective surface connecting the light emitting surface and the light refractive surface; and
a second light reflective surface connecting the light emitting surface and the light refractive surface and opposite to the first light reflective surface;
wherein the point light source is received in a space defined by the light refractive surface.

3. The light assembly according to claim 1, wherein the lens comprises two light reflective lens bodies disposed opposite to each other.

4. The light assembly according to claim 3, wherein the two light reflective lens bodies have curved reflective surfaces.

5. The light assembly according to claim 1, wherein the lens comprises:
two light reflective lens bodies disposed opposite to each other; and
a light emitting lens body connects the top portions of the two light reflective lens bodies.

6. The light assembly according to claim 1, wherein the lens comprises a curved body.

7. The light assembly according to claim 1, wherein the light assembly comprises seven light bars arranged in a number 8 layout.

8. The light assembly according to claim 1, wherein the light assembly comprises three light bars arranged in an arrow layout.

9. The light assembly according to claim 1, wherein the light assembly comprises four light bars arranged in a letter X layout.

10. A light assembly, comprising:
a luminous pattern constituted by a plurality of light bars, wherein each of the light bars comprises:
at least one point light source for emitting a light; and
a lens disposed over the point light source for directing the light emitted from the point light source along an extending direction of the light bar.

11. The light assembly according to claim 11, wherein the lens comprises a lens body having:
a light emitting surface;
a light refractive surface;
a first light reflective surface connecting the light emitting surface and the light refractive surface; and
a second light reflective surface connecting the light emitting surface and the light refractive surface and opposite to the first light reflective surface;
wherein the point light source is received in a space defined by the light refractive surface.

12. The light assembly according to claim 11, wherein the lens comprises two light reflective lens bodies disposed opposite to each other.

13. The light assembly according to claim 13, wherein the two light reflective lens bodies have curved reflective surfaces.

14. The light assembly according to claim 11, wherein the lens comprises:
two light reflective lens bodies disposed opposite to each other; and
a light emitting lens body connects the top portions of the two light reflective lens bodies.

15. The light assembly according to claim 11, wherein the lens comprises a curved body.

16. The light assembly according to claim 11, wherein the luminous pattern is a number 8 constituted by seven light bars.

17. The light assembly according to claim 11, wherein the luminous pattern is an arrow constituted by three light bars.

18. The light assembly according to claim 11, wherein the luminous pattern is a letter X constituted by four light bars.
